(19) United States
(12) Patent Application Publication
(10) Pub. No.: US 2011/0301818 A1
(43) Pub. Date: Dec. 8, 2011

(54) ROTARY ENCODER GEAR SELECTOR FOR VEHICLE

(75) Inventors: Alex Hamade, Santa Monica, CA (US); Broc William TenHouten, Santa Monica, CA (US); Kevin Robert Czinger, Brentwood, CA (US); David Leslie Edwards, Newburgh, IN (US)

(73) Assignee: Coda Automotive, Inc., Santa Monica, CA (US)

(21) Appl. No.: 13/104,418

(22) Filed: May 10, 2011

Related U.S. Application Data
(60) Provisional application No. 61/334,369, filed on May 13, 2010.

(51) Int. Cl. F16H 59/02

(52) U.S. Cl. 701/51

(57) ABSTRACT

Gear selector apparatus for a vehicle includes a rotary encoder having detents at positions corresponding to driving modes of the vehicle, the rotary encoder outputting at least one encoder signal in response to rotation of the rotary encoder by a driver of the vehicle, a display assembly configured to indicate a driving mode of the vehicle, and gear selector logic, responsive at least in part to the encoder signal, to control the driving mode of the vehicle and the display assembly. The rotary encoder may be rotatable in either direction without limits on rotation. The gear selector logic may define one or more conditions for changing from an actual driving mode to a target driving mode selected by the driver.

### RELATED APPLICATIONS

This application claims priority under 35 U.S.C. §119(e) to U.S. Provisional Patent Application No. 61/334,369, filed May 13, 2010, and entitled, “Rotary Encoder Gear Selector for Vehicle,” which is incorporated herein by reference in its entirety for all purposes.

### FIELD OF THE INVENTION

This invention relates to gear selection apparatus and methods for a vehicle and, more particularly, to a rotary encoder gear selector.

### BACKGROUND OF INVENTION

A wide variety of gear selectors for vehicles are known. The gear selector enables the driver to control different operating modes of the vehicle, such as park, reverse, neutral and drive, for example. The gear selector controls the transmission and may control other vehicle components, such as a parking pawl. Gear selectors have included conventional mechanical shift levers which are mechanically linked to the transmission and so-called shift-by-wire gear selectors. The shift-by-wire gear selectors employ an electronic controller between the gear selector mechanism and the transmission being controlled. Gear selectors may involve movement of a shift lever along a known path to different positions. Rotary gear selectors are also known, in which the driver rotates a shift knob to different positions.

The shift-by-wire gear selector may reduce mechanical complexity but requires various interlocks for proper operation. For example, the gear selector mechanism may permit the driver to shift from drive to reverse when the vehicle is moving in a forward direction. However, such operation, even if inadvertent, may cause undesired or unsafe operation of the vehicle and may damage the drive train of the vehicle.

All of the prior art gear selectors for vehicles have had one or more disadvantages, including but not limited to mechanical complexity, high cost, large size and lack of reliability. Accordingly, there is a need for improved gear selector systems and methods for vehicles.

### SUMMARY OF INVENTION

According to a first aspect of the invention, a gear selector apparatus for a vehicle comprises a rotary encoder having detents at positions corresponding to driving modes of the vehicle, the rotary encoder outputting at least one encoder signal in response rotation of the rotary encoder by a driver of the vehicle, a display assembly configured to indicate a driving mode of the vehicle, and gear selector logic, responsive at least in part to the encoder signal, to control a driving mode of the vehicle and the display assembly. The rotary encoder may be rotatable in either direction without limits on rotation. The gear selector logic may define one or more conditions for changing from an actual driving mode to a target driving mode selected by the driver.

According to a second aspect of the invention, a gear selector assembly for a vehicle comprises a rotary encoder having detents at positions corresponding to driving modes of the vehicle, the rotary encoder outputting at least one encoder signal in response to rotation of the rotary encoder by a driver of the vehicle; a display assembly configured to indicate a driving mode of the vehicle; and a housing configured for mounting the rotary encoder and the display assembly in a prescribed relationship.

According to a third aspect of the invention, a method for selecting a driving mode of a vehicle comprises generating at least one encoder signal in response to rotation of a rotary encoder by a driver of the vehicle; and controlling a driving mode of the vehicle responsive at least in part to the encoder signal.

### BRIEF DESCRIPTION OF DRAWINGS

For a better understanding of the present invention, reference is made to the accompanying drawings, which are incorporated herein by reference and in which:

FIG. 1 is a perspective view of a gear selector assembly in accordance with embodiments of the invention;

FIG. 2 is a schematic block diagram of a gear selector assembly and gear selector logic in accordance with embodiments of the invention;

FIG. 3 illustrates examples of waveforms of encoder signals output by the rotary encoder;

FIG. 4 is a block diagram of the gear selector logic shown in FIG. 2;

FIG. 5 is a flow diagram of a driving mode transition in accordance with embodiments of the invention;

FIG. 6 is a flow diagram of driving mode initialization in accordance with embodiments of the invention; and

FIG. 7 is a flow diagram of driving state detection in accordance with embodiments of the invention.

### DETAILED DESCRIPTION

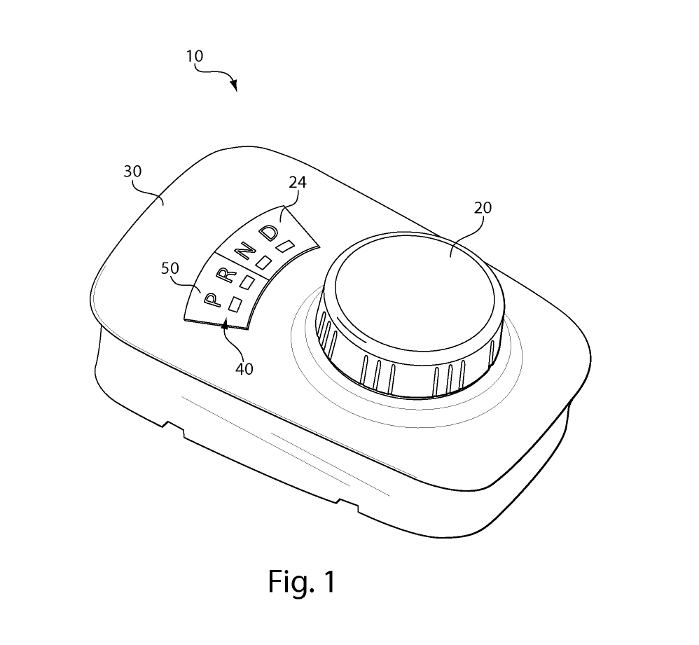

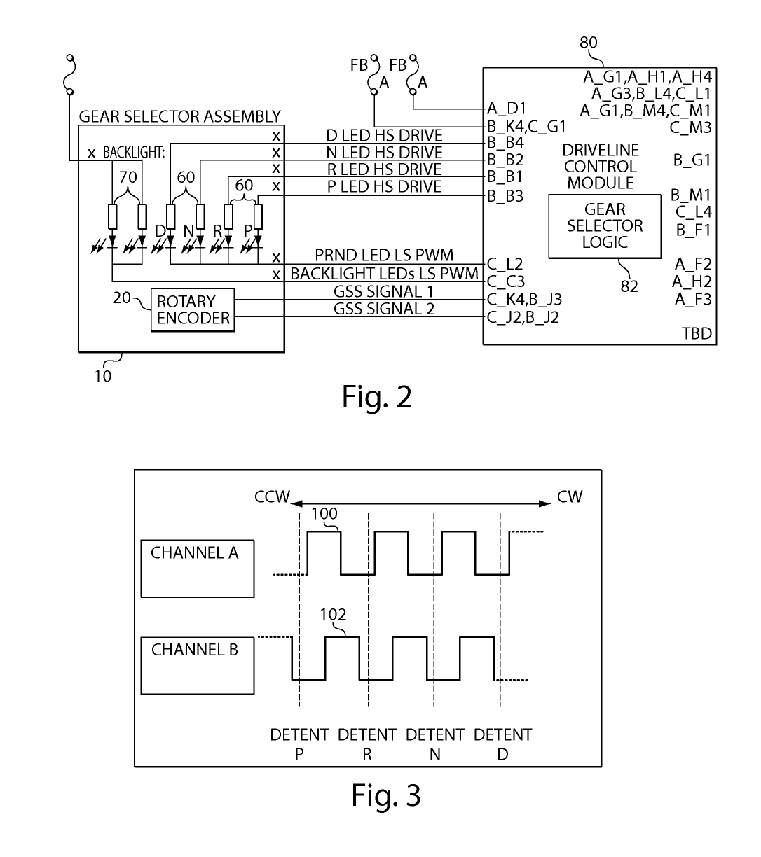

A gear selector assembly 10 in accordance with embodiments of the invention is shown in FIGS. 1 and 2. The gear selector assembly 10 includes a rotary encoder 20 and a display assembly 24 mounted in a housing 30. The housing 30 is configured for mounting in an appropriate location in a vehicle (not shown).

The rotary encoder 20 may be a rotary switch having a knob for operation by the driver. The rotary encoder generates one or more electronic signals as the knob is rotated. In some embodiments, the rotary encoder 20 generates first and second encoder signals, as shown by way of example in FIG. 3. The rotary encoder 20 may include several detents at positions corresponding to driving modes of the vehicle. In some embodiments, the rotary encoder 20 has detents spaced apart by 22.5 degrees at positions corresponding to park (P), reverse (R), neutral (N) and drive (D) driving modes. In some embodiments, the rotary encoder 20 is rotatable in clockwise and counterclockwise directions without limitations on rotation. Thus, the rotary encoder 20 can be rotated by 360 degrees, and the driving mode is controlled as described below.

The display assembly 24 includes jewels 40 mounted in a display panel 50. One jewel 40 corresponds to each of the P, R, N and D driving modes. As shown in FIG. 2, driving mode LEDs (light emitting diodes) 60 are positioned behind respective jewels 40 to illuminate the jewel for a selected driving mode. Display assembly 24 further includes backlight LEDs 70 for illuminating display panel 50.

As further shown in FIG. 2, gear selector assembly 10 provides encoder signals to a driveline control module 80 and receives control signals from driveline control module 80. Driveline control module 80 includes gear selector logic 82 which controls gear selection as described below. In particular, driveline control module 80 controls driving mode LEDs 60 in accordance with the driving mode determined by gear selector logic 82 and controls backlight LEDs 70, typically according to ambient lighting conditions.

An example of encoder signals output by rotary encoder 20 during rotation by a driver is shown in FIG. 3. In the embodiment of FIG. 3, rotary encoder 20 outputs a first encoder signal 100 and a second encoder signal 102 as the rotary encoder is rotated through detents corresponding to P, R, N, and D driving modes. As shown, signals 100 and 102 each alternate between two digital states, with one complete cycle for each rotation between adjacent detents. Further, encoder signals 100 and 102 are out of phase with respect to each other. The encoder signals for clockwise rotation progress from left to right in FIG. 3, and the encoder signals for counterclockwise rotation progress from right to left in FIG. 3. The direction of rotation can be determined from the relative phases of the two encoder signals. The gear selector logic 82 analyzes first and second encoder signals 100 and 102 to determine the amount and direction of rotation. Thus, for example, the vehicle may currently be in the P driving mode. A rotation of rotary encoder 20 which produces three cycles of encoder signals 100 and 102 in a clockwise direction is identified by gear selector logic 82 as a rotation to the D driving mode.

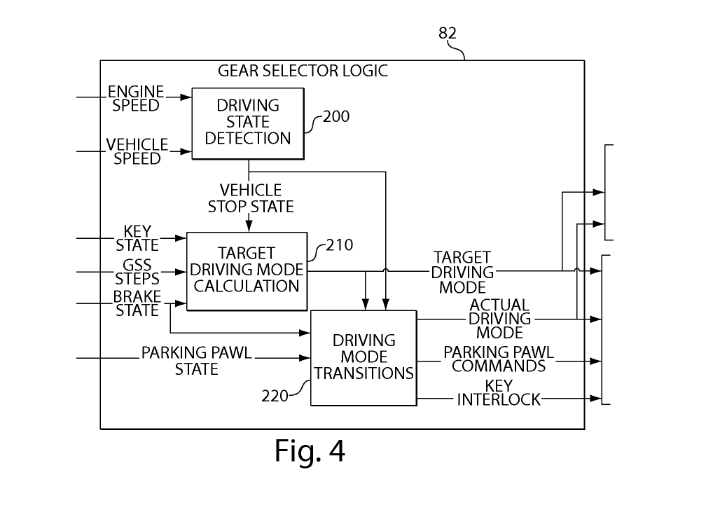

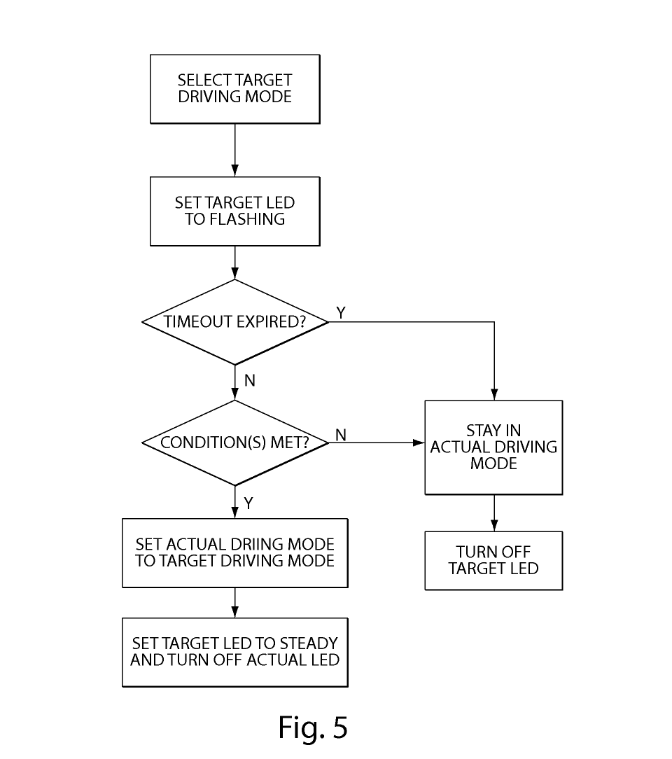

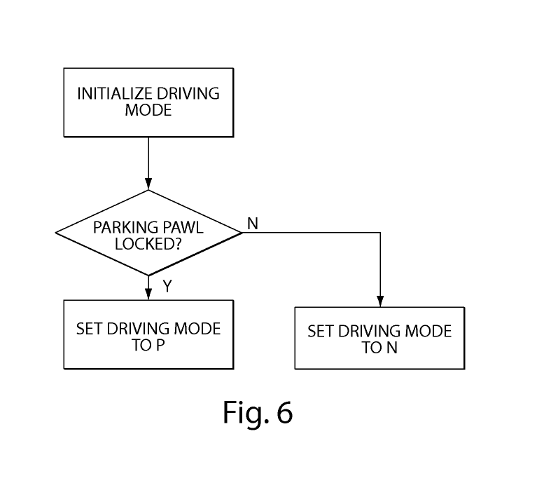

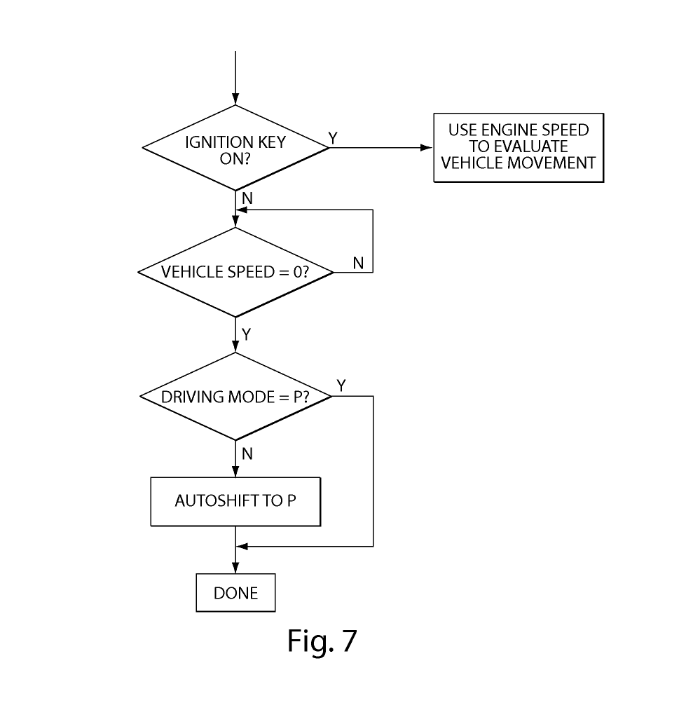

A block diagram of gear selector logic 82 is shown in FIG. 4. A driving state detection module 200 receives engine speed and vehicle speed, and outputs a vehicle stop state. A target driving mode calculation module 210 receives the vehicle stop state, a key state, the encoder signals described above and a brake state, and outputs a target driving mode. A driving mode transition module 220 receives the vehicle stop state, the target driving mode, the brake state, and a parking pawl state, and outputs an actual driving mode, parking pawl commands and a key interlock. The gear selector logic 82 can be implemented as a programmed microprocessor, a custom logic circuit, or any other suitable logic circuitry.

The gear selector logic 82 manages the driving mode of the vehicle as described below. The gear selector input from the driver, via the first and second encoder signals 100 and 102, is converted to target driving mode (P, R, N, and D). Depending on the actual driving mode and vehicle states, transitions from the actual driving mode to the target driving mode are performed. The parking pawl lock and unlock request and the key interlock are set according to the actual and target driving modes.

When the vehicle is in motion, the possible shift operations depend on the driving direction. Two speed signals can be evaluated in different key states by driving state detection module 200. A motor control module is powered only in ignition-on state and provides a signed engine speed signal. The electronic stability control is powered by the driveline control module 80 in the ignition-off state. The electronic stability control provides an unsigned vehicle speed signal. For shift conditions, the engine speed can be used when the ignition is on. After ignition off, the vehicle speed is used for the evaluation of the autoshift to park conditions.

Vehicle movement is detected via engine speed (feedback from the motor control module) in both directions. The forward movement flag is set if the engine speed is above a high threshold. The forward movement flag is reset if engine speed is below a low threshold for a debounce time. The reverse movement flag is set if engine speed is below a low threshold and is reset if engine speed is above a high threshold for a debounce time. When the ignition is on, the vehicle stop state is detected if both forward and reverse motion flags are reset. When the ignition is off, the vehicle stop state is detected if the vehicle speed (feedback from electronic stability control) is below a low threshold for a debounce time.

The actual driving mode may be defined as the current driving mode of the vehicle and determines vehicle operation. The target driving mode represents a driver selection, as read from the rotary encoder 20. The actual driving mode changes based on the vehicle states and the target driving mode. The target driving mode calculation module 210 determines the target driving mode based on the encoder signals and other state signals that indicate the state of the vehicle.

The target driving mode is initialized to “unknown”. When the actual state of the parking pawl is read, the target driving mode is set to the value of the actual driving mode.

If a gear selector rotation (movement of the rotary encoder 20 from one detent to the next) in a clockwise direction is detected, the target driving mode is changed in the order P, R, N, D, with one transition per step of rotary encoder 20. For gear selector rotation in the counterclockwise direction, the target driving mode is changed in reverse order. The target driving mode is stopped at driving mode D for clockwise rotation and is stopped at driving mode P for counterclockwise rotation. Thus, clockwise rotation of rotary encoder 20 beyond driving mode D produces no change in driving mode, and counterclockwise rotation beyond driving mode P produces no change in driving mode.

The transition time is counted as long as the target driving mode and the actual driving mode are not equal. The transition time is reset to zero if the target driving mode changes. When the transition time exceeds a threshold, the target driving mode is set to the value of the actual driving mode. In this case, the attempted shift is aborted.

When the ignition is turned off, the system sets the target driving mode to driving mode P automatically.

The actual driving mode is initialized to “unknown.” When the state of the parking pawl is read, the actual driving mode is set to P in case of a locked parking pawl and is set to N in case of an unlocked parking pawl.

Transitions into actual driving mode R are allowed, if vehicle forward movement is not detected. Transitions into actual driving mode D are allowed, if vehicle reverse movement is not detected.

Transitions out of driving mode P are allowed if the following conditions are true:

(1) the drive sensor signal from the transaxle is set, and

(2) the parking pawl position is “unparked” or “unparked stalled.”

Transitions into driving mode P are allowed, if the following conditions are true:

(1) the park sensor signal from the transaxle is set, and

(2) the parking pawl position is “parked” or “parked stalled.”

The park request for the parking pawl is set, if the following conditions are true:

(1) the target driving mode is P,

(2) the drive sensor signal from the transaxle is set,

(3) the parking pawl position is “unparked,”

(4) the vehicle stop state is detected, and

(5) the brake is pressed.

The unpark request for the parking pawl is set, if the following conditions are true:

(1) the target driving mode is not P,

(2) the park sensor signal from the transaxle is set,

(3) the parking pawl position is “parked,”

(4) the vehicle stop state is detected, and

(5) the brake is pressed.

The key interlock solenoid is activated or deactivated depending on the actual driving mode and the target driving mode. If the key interlock is set, the key cannot be removed from the vehicle. The key interlock is set if the target driving mode is not P. The key interlock is reset, if the target driving mode and the actual driving mode are P.

After an ignition off event, the driveline control module 80 continues to use the self-power enable relay as a power supply. When the vehicle is in park and the power latch phase has finished, the self-power enable relay is released and the driveline control module is switched off. The driveline control module is kept awake until the actual and target driving modes are P again.

The actual driving mode may be illuminated in the instrument cluster of the vehicle and on the display assembly 24 of the gear selector assembly 10. If the actual driving mode and the target driving mode are not equal, the target driving mode is illuminated with a flashing LED on the display assembly 24. A flashing period may be defined by adjustable on and off durations. When the driving mode is changed, the new LED starts with the flashing period in the on state.

U.S. Provisional Patent Application No. 61/334,369, filed May 13, 2010, and entitled “Rotary Encoder Gear Selector for Vehicle” is incorporated herein by reference in its entirety for all purposes.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. Gear selector apparatus for vehicle, comprising:
a rotary encoder having detents at positions corresponding to driving modes of the vehicle, the rotary encoder outputting at least one encoder signal in response to rotation of the rotary encoder by a driver of the vehicle;
a display assembly configured to indicate a driving mode of the vehicle; and
gear selector logic, responsive at least in part to the encoder signal, to control the driving mode of the vehicle and the display assembly.

2. Gear selector apparatus as defined in claim 1, wherein the rotary encoder includes detents for P, R, N, and D driving modes.

3. Gear selector apparatus as defined in claim 2, wherein the display assembly includes indicator lights for P, R, N, and D driving modes.

4. Gear selector apparatus as defined in claim 1, wherein the rotary encoder is rotatable in either direction without limits on rotation.

5. Gear selector apparatus as defined in claim 3, wherein an actual driving mode is indicated by steady illumination of a corresponding indicator light and wherein a target driving mode is indicated by flashing illumination of a corresponding indicator light.

6. Gear selector apparatus as defined in claim 5, wherein the indicator light corresponding to the target driving mode flashes and then switches to steady illumination if the target driving mode becomes the actual driving mode or turns off if the target driving mode does not become the actual driving mode in a predetermined time after selection of the target driving mode.

7. Gear selector apparatus as defined in claim 1, wherein the gear selector logic defines at least one condition for changing from an actual driving mode to a target driving mode.

8. Gear selector apparatus as defined in claim 1, wherein the gear selector logic provides control signals for autoshifting to park driving mode when the ignition key is off and the vehicle speed is zero.

9. Gear selector apparatus as defined in claim 1, wherein the encoder signal comprises at least one alternating encoder signal having one cycle for rotation of the rotary encoder between adjacent detents.

10. Gear selector apparatus as defined in claim 1, wherein the encoder signal comprises first and second alternating signals having one cycle corresponding to rotation of the rotary encoder between adjacent detents, the first and second alternating signals being phase shifted relative to each other.

11. Gear selector apparatus as defined in claim 3, wherein the indicator lights of the display assembly are controlled for bright illumination in daytime and less bright illumination at night.

12. Gear selector apparatus as defined in claim 3, wherein the indicator lights of the display assembly are dimmable.

13. Gear selector apparatus as defined in claim 1, further including a housing configured for mounting of the rotary encoder and the display assembly, wherein the rotary encoder, the display assembly and the housing comprise a gear selector assembly.

14. Gear selector apparatus as defined in claim 4, wherein the rotary encoder defines a plurality of selectable driving modes and wherein the gear selector logic is configured such that rotation of the rotary encoder beyond the selectable driving modes produces no change in driving mode.

15. A gear selector assembly for a vehicle, comprising:
a rotary encoder having detents at positions corresponding to driving modes of the vehicle, the rotary encoder outputting at least one encoder signal in response to rotation of the rotary encoder by a driver of the vehicle;
a display assembly configured to indicate a driving mode of the vehicle; and
a housing configured for mounting the rotary encoder and the display assembly in a prescribed relationship.

16. A method for selecting a driving mode of a vehicle, comprising:
generating at least one encoder signal in response to rotation of a rotary encoder by a driver of the vehicle; and
controlling a driving mode of the vehicle responsive at least in part to the encoder signal.
